(19) United States
(12) Patent Application Publication
(10) Pub. No.: US 2008/0164993 A1
(43) Pub. Date: Jul. 10, 2008

(54) Vehicle brake light system and vehicle comprising same

(76) Inventor: Charles V. Douglas, Camden, TN (US)

Correspondence Address: David O. Simmons;Galasso & Associates LP, P.O. Box 26503, Austin, TX, 78755-0503, US

(21) Appl. No.: 11/649,614

(22) Filed: Jan. 4, 2007

(51) Int. Cl. B60Q 1/44

(52) U.S. Cl. 340/479

(57) ABSTRACT

A vehicle brake light system comprises a brake light assembly and a brake light controller. The brake light assembly includes a plurality of braking effort intensity indication lights each configured for being selectively illuminated through the application of electrical power and an alert light configured for being selectively illuminated through the application of electrical power. The brake light controller is electrically connected to the lights of the brake light assembly. The brake light controller causes electrical power to be selectively applied to at least a portion of the braking effort intensity indicating lights dependent upon a relative degree of braking effort being sensed by the brake light controller. The brake light controller causes electrical power to be intermittently applied to the alert light during a prescribed braking effort upper threshold being sensed by the brake light controller and/or the brake light controller receiving a signal corresponding to the motor vehicle being stopped.

### FIELD OF THE DISCLOSURE

The disclosures made herein relate generally to vehicle signalling light systems and, more particularly, to vehicle brake light systems.

### BACKGROUND

Many motor vehicle accidents that inflict injury or death on those involved are “rear end” collisions. Typically, this type of accident is the result of a driver of a following vehicle lacking knowledge of the rate of deceleration of the leading vehicle. Current vehicles are equipped with conventional brake lights, which illuminate in accordance with the application of the braking mechanism that indicate the leading vehicle is either slowing down or has stopped. Unfortunately, especially at night, such limited information does not fully inform a following vehicle of the status of the motor vehicle. For instance, for waning traffic participants who are following a leading vehicle, the application of the brakes of the leading vehicle is conventionally indicated with two or three brake lights located on the rear exterior of the motor vehicle. In road traffic, a driver of a vehicle following the leading vehicle is momentarily informed only that the driver of the leading vehicle is operating the brake pedal. This visual signal provides limited direct information to the following driver concerning the actual intensity of the braking or the deceleration of the leading vehicle. Accordingly, the following driver must observe and assess additional visual information to determine the deceleration of the leading vehicle, for example, by recognizing how fast the relative gap between the two vehicles is changing. Depending on how well the following driver detects and assesses this secondary visual information, the following driver must attempt to adapt the speed and the gap more or less to the motor vehicle driving ahead.

Therefore, a brake light system that provides indication of an intensity of braking effort is advantageous, desirable and useful.

### SUMMARY OF THE DISCLOSURE

Embodiments of the present invention relate to brake light systems in motor vehicles that provide indication of an intensity of braking effort. More specifically, embodiments of the present invention illuminate a quantity of brake lights proportional to the intensity of braking effort and illuminate an alert light in response to a braking effort exceeding a prescribed braking effort upper threshold or in response to the vehicle braking to a speed below a prescribed minimum speed. In this manner, embodiments of the present invention are advantageous, desirable and useful in that they reduce the potential for a motor vehicle equipped with a brake light system in accordance with the present invention from being in a rear-end collision.

In one embodiment of the present invention, a vehicle brake light system comprises a brake light assembly and a brake light controller. The brake light assembly includes a plurality of braking effort intensity indication lights each configured for being selectively illuminated through the application of electrical power and an alert light configured for being selectively illuminated through the application of electrical power. The brake light controller is electrically connected to the lights of the brake light assembly. The brake light controller causes electrical power to be selectively applied to at least a portion of the braking effort intensity indicating lights dependent upon a relative degree of braking effort being sensed by the brake light controller. The brake light controller causes electrical power to be intermittently applied to the alert light during a prescribed braking effort upper threshold being sensed by the brake light controller and/or the brake light controller receiving a signal corresponding to the motor vehicle being stopped.

In another embodiment of the present invention, a vehicle brake light system comprises a brake light assembly, a braking effort sensing apparatus and an electrical power output apparatus. The brake light assembly includes a plurality of lights each configured for being selectively illuminated through the application of electrical power. The braking effort sensing apparatus is configured for sensing a relative degree of braking effort corresponding to applied braking force within a brake system of a motor vehicle, converts the relative degree of braking effort to a corresponding electrical signal and provides the corresponding electrical signal to the brake light assembly. The electrical power output apparatus is electrically connected between the braking effort sensing apparatus and the lights of the brake light assembly. The electrical power output apparatus causes electrical power to be selectively applied to at least a portion of the lights dependent upon the corresponding electrical signal. The electrical power output apparatus causes electrical power to be intermittently applied to at least a portion of the lights during a prescribed braking effort upper threshold being sensed by the braking effort sensing apparatus and/or the electrical power output apparatus receiving a signal corresponding to the motor vehicle being stopped.

In another embodiment of the present invention, a motor vehicle comprises a brake system controller, a plurality of braking effort intensity indication lights, an alert light and a brake light controller. The brake system controller is configured for outputting a brake effort signal proportional to a relative degree of braking effort. The braking effort intensity indication lights are each configured for being selectively illuminated through the application of electrical power. The alert light is configured for being selectively illuminated through the application of electrical power. The brake light controller is electrically connected to the brake system controller, braking effort intensity indication lights and the alert light. The brake light controller causes electrical power to be selectively applied to at least a portion of the braking effort intensity indicating lights dependent upon the braking effort signal. The brake light controller causes electrical power to be intermittently applied to the alert light during the braking effort signal corresponding to a prescribed braking effort upper threshold being sensed by the brake system controller and/or the brake light controller receiving a signal corresponding to the motor vehicle being stopped.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts an illustrative view showing a brake light assembly in accordance with the present invention mounted on a vehicle.

FIG. 2 is top view of the brake light assembly shown in FIG. 1.

FIG. 3 is front view of the brake light assembly shown in FIG. 1.

FIG. 4 is an illustrative view showing a vehicle brake light system in accordance with the present invention.

FIG. 5 is a table showing an embodiment of a zone illumination strategy in accordance with the present invention.

### DETAILED DESCRIPTION OF THE DRAWING FIGURES

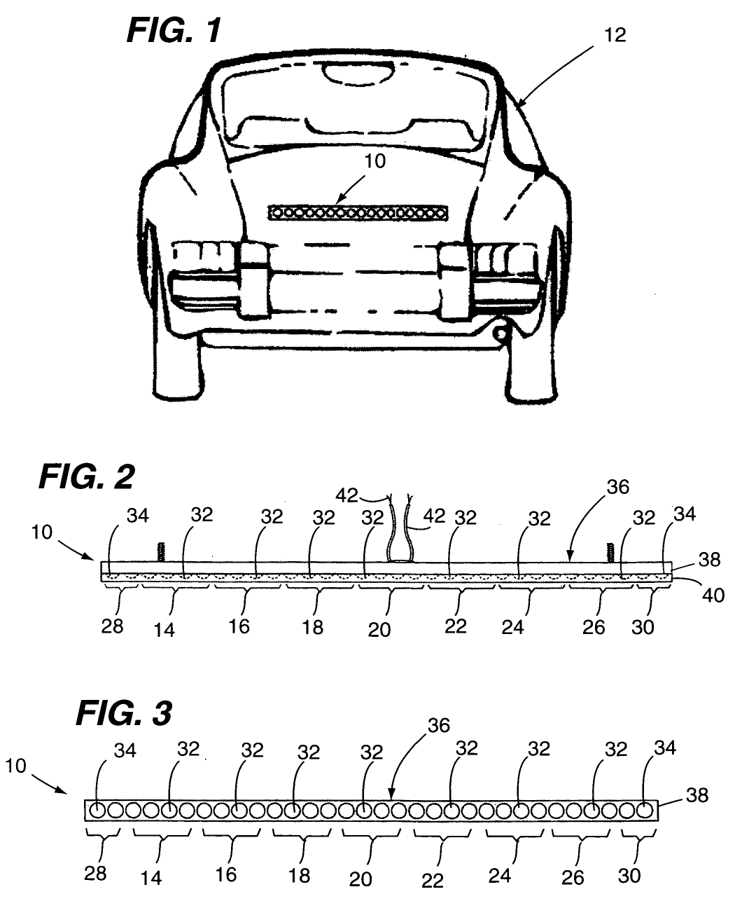

FIGS. 1-3 shows an embodiment of a brake light assembly in accordance with the present invention, which is referred to herein as the brake light assembly 10. As shown in FIG. 1, the brake light assembly 10 is attached to a motor vehicle 12 in a rearward-facing manner, which is the typical mounted orientation for a brake light assembly. It is disclosed herein that, in other embodiments of the present invention, the brake light assembly 12 may be attached to a motor vehicle in a forward-facing or side-facing manner. A brake light assembly in accordance with the present invention is not unnecessarily limited to a particular mounted orientation.

The brake light assembly 10 includes a plurality of braking effort intensity indication light zones (14-26) and a plurality of alert light zones (28, 30). Each one of the braking effort intensity indication light zones (14-26) includes a plurality of braking effort intensity indication lights 32 and each one of the alert light zones (28, 30) includes a plurality of alert lights 34. It is disclosed herein that all or a portion of the braking effort intensity indication light zones (14-26) may each include only one braking effort intensity indication light 32 and that all or a portion of the alert light zones (28, 30) may each include only one alert light 34.

The braking effort intensity indication lights 32 and the alert lights 34 are mounted on a lighting assembly housing 36 including a main body 38 and a lens cover 40 (FIG. 2). In one embodiment, the lens cover 40 is configured such that braking effort intensity indication lights 32 cause light visible as being red in color to be emitted and the alert lights 34 cause light visible as being amber in color to be emitted. In another embodiment, the braking effort intensity indication lights 32 are red in color (i.e., a first color scheme) such that light emitted therefrom is visibly red and the alert lights 34 are amber in color (i.e., a second color scheme) such that light emitted therefrom is visibly amber.

The braking effort intensity indication lights 18 and the alert lights 20 are aligned in a row. Thus, the braking effort intensity indication light zones (14-26) and the alert light zones (28, 30) are all in a row. The first alert light zone 28 is immediately adjacent the first braking effort intensity indicating light zone 14, which is immediately adjacent the second braking effort intensity indicating light zone 16, which is immediately adjacent the third braking effort intensity indicating light zone 18, which is immediately adjacent the fourth braking effort intensity indicating light zone 20, which is immediately adjacent the fifth braking effort intensity indicating light zone 22, which is immediately adjacent the sixth braking effort intensity indicating light zone 24, which is immediately adjacent the seventh braking effort intensity indicating light zone 26, which is immediately adjacent the second alert light zone 30. It is disclosed herein that the light zones (14-30) need not be in a single row. It is disclosed here in that they may be in multiple rows, in concentric circles or other configuration.

The braking effort intensity indication lights 32 and the alert lights 34 are each configured for being selectively illuminated through the application of electrical power. The lighting assembly 10 includes electrical conductors 42 that are electrically connected to each one of the braking effort intensity indication lights 32 and the alert lights 34. Such interconnection of the electrical conductors 42 with the braking effort intensity indication lights 32 and the alert lights 34 enables such electrical power to be provided to the braking effort intensity indication lights 32 and the alert lights 34. In one embodiment, each one of the braking effort intensity indication lights 32 and the alert lights 34 includes a light bulb and a light bulb base such that each light bulb base holds a respective light bulb and facilitates electrical power being provided to the respective light bulb.

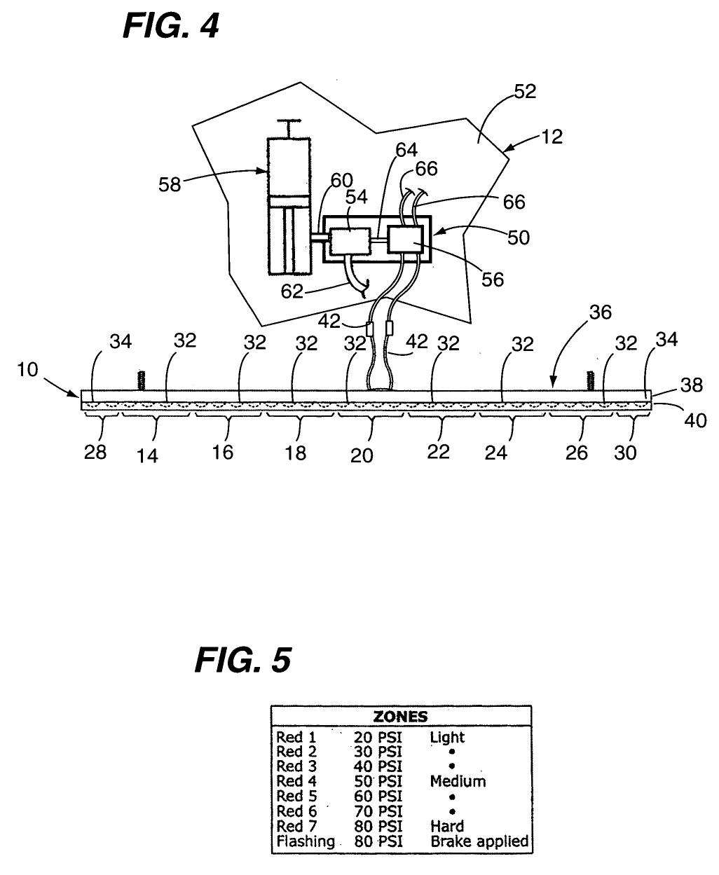

Referring now to FIG. 4, an embodiment of a brake light controller in accordance with the present invention is shown and referred to herein as the brake light controller 50. The brake light controller 50 is mounted to a chassis component 52 (e.g., a firewall) of the motor vehicle 12 and is electrically connected to the lights (32, 34) of the brake light assembly 10 through the electrical conductors 42. The brake light controller 50 causes electrical power to be selectively applied to the braking effort intensity indicating lights 32 dependent upon a relative degree of braking effort being sensed by the brake light controller 50 and causes electrical power to be intermittently applied to the alert lights 34 during a prescribed braking effort upper threshold being sensed by the brake light controller 34 and/or the brake light controller receiving a signal corresponding to the motor vehicle 12 being stopped. A vehicle brake light system in accordance with at least one embodiment of the present invention comprises the brake light controller 50 and the brake light assembly 10

As depicted in FIG. 4, the brake light controller includes a braking effort sensing apparatus 54 and an electrical power output apparatus 56. The braking effort sensing apparatus 56 senses a relative degree of braking effort corresponding to braking force applied by brake system components 58 of the motor vehicle 12 and providing a corresponding electrical signal to the electrical power output apparatus 56. The electrical power output apparatus 56 is electrically connected between the braking effort sensing apparatus 54 and the brake light assembly 10. The braking effort sensing apparatus 54 is hydraulically connected to the brake system component 58 (e.g., master cylinder, anti-lock brake system, proportioning valve, brake lines, etc) of the vehicle 10 through an upstream hydraulic line 60. Depending on the specific application and system requirements, hydraulic line pressure may be provided to brake system components downstream of the braking effort sensing apparatus 54 through a downstream hydraulic line 62. In operation, the braking effort sensing apparatus 54 senses a hydraulic brake line pressure level, converts the hydraulic brake line pressure level to the corresponding electrical signal discussed above and provides the corresponding electrical signal to the electrical power output apparatus 56 via a electrical conductor 64. Dependent upon the corresponding electrical signal (e.g., an analog voltage or a digital value), the electrical power output apparatus 56 applies electrical power to appropriate ones of the braking effort intensity indication lights 32 and/or the alert lights 34 via electrical conductors 42 of the brake light assembly 12. Electrical power is supplied to the electrical power output apparatus 56 through power supply conductors 66.

In another embodiment, the braking effort sensing apparatus 54 is mechanically connected to the brake system component 58 (e.g., brake pedal assembly, calliper, wheel cylinder, etc) of the vehicle 10. In such an embodiment, the braking effort sensing apparatus 54 senses a mechanical force level (e.g., force exerted within the brake pedal assembly), converts the mechanical force level to the corresponding electrical signal discussed above and provides the corresponding electrical signal to the electrical power output apparatus 56.

In one operational embodiment of the present invention, the electrical power output apparatus 56 applies electrical power to the braking effort intensity indicating lights 32 of the first braking effort intensity indicating light zone 14 (i.e., a first portion of the braking effort intensity indicating lights 32) during a first relative degree of braking effort being sensed by the braking effort sensing apparatus 54, also applies electrical power to the braking effort intensity indicating lights 32 of the second braking effort intensity indicating light zone 16 (i.e., a second portion of the braking effort intensity indicating lights 32) during a second relative degree of braking effort being sensed by the braking effort sensing apparatus 54, also applies electrical power to the braking effort intensity indicating lights 32 of the third braking effort intensity indicating light zone 18 (i.e., a third portion of the braking effort intensity indicating lights 32) during a third relative degree of braking effort being sensed by the braking effort sensing apparatus 54 and, accordingly, so on dependent upon the relative degree of braking effort. In this manner, an appropriate number of the braking effort intensity indicating light zones (14-26) are sequentially illuminated dependent upon the relative degree of braking effort. It should be understood that preferably, but not necessarily, the second braking effort intensity indicating light zone 16 is illuminated while the first braking effort intensity indicating light zone 14 is illuminated, that the third braking effort intensity indicating light zone 18 is illuminated while the second braking effort intensity indicating light zone 16 is illuminates, and so on. In this manner, the braking effort intensity indicating light zones illuminate in a progressive manner dependent upon the relative degree of braking effort being sensed by the braking effort sensing apparatus 54.

Referring now to FIG. 5, an embodiment of a zone illumination strategy is shown. For each braking effort intensity indicating light zones (14-26), a corresponding hydraulic line pressure is prescribed (i.e., red 1 zone through red 7 zone correspond respectively to braking effort intensity indicating light zones 14-26). Upon the braking effort sensing apparatus 54 a particular hydraulic line pressure (e.g., 20 psi), electrical power is applied to the corresponding one of the braking effort intensity indicating light zones (e.g., red 1 zone in FIG. 5, which is the first braking effort intensity indicating light zone 14). Accordingly, each braking effort intensity indicating light zone (i.e., red 1 zone through red 7 zone correspond respectively to braking effort intensity indicating light zones 14-26) corresponds to a respective hydraulic pressure and relative degree of braking effort (e.g., light, medium hard, panic, etc). When a prescribed braking effort upper threshold (e.g., 80 psi, which might correspond to a panic stop) is sensed by the braking effort sensing apparatus 54, electrical power is intermittently applied to the alert light zones 28, 30 (i.e., flashing zone in FIG. 5).

It is disclosed herein that a braking effort sensing apparatus may be an integral component of a brake system controller of a motor vehicle. In such case, a vehicle brake light system in accordance with the present invention does not need to include a braking effort sensing apparatus, in view of braking effort signals being provided from the brake system controller of the motor vehicle to the electrical power output apparatus 56 of the vehicle brake light system 12. Accordingly, a vehicle brake light system in accordance with the present invention may be configured for being installed as an original equipment option by a vehicle manufacturer or for being installed as an aftermarket item (i.e., e.g., installed by a dealer, a car owner or third party).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle brake light system, comprising:
a brake light assembly including a plurality of braking effort intensity indication lights each configured for being selectively illuminated through the application of electrical power and an alert light configured for being selectively illuminated through the application of electrical power; and
a brake light controller electrically connected to said lights of the brake light assembly, wherein the brake light controller causes electrical power to be selectively applied to at least a portion of said braking effort intensity indicating lights dependent upon a relative degree of braking effort being sensed by the brake light controller and wherein the brake light controller causes electrical power to be intermittently applied to the alert light during at least one of a prescribed braking effort upper threshold being sensed by the brake light controller and the brake light controller receiving a signal corresponding to the motor vehicle being stopped.

2. The vehicle brake light system of claim 1 wherein:
the brake light controller includes a braking effort sensing apparatus and an electrical power output apparatus;
the braking effort sensing apparatus is configured for sensing the relative degree of braking effort corresponding to applied braking force within a brake system of a motor vehicle and providing a corresponding electrical signal to the electrical power output apparatus;
the electrical power output apparatus is electrically connected between the braking effort sensing apparatus and the brake light assembly; and
the electrical power output apparatus outputs electrical power to the brake light assembly dependent upon the corresponding electrical signal for causing said electrical power to be selectively applied to said at least a portion of said braking effort intensity indicating lights dependent upon the relative degree of braking effort being sensed by the braking effort sensing apparatus and for causing said electrical power to be intermittently applied to the alert light during at least one of the prescribed braking effort upper threshold being sensed by the brake light controller and the brake light controller receiving the signal corresponding to the motor vehicle being stopped.

3. The vehicle brake light system of claim 2 wherein the braking effort sensing apparatus:
senses a hydraulic brake line pressure level within the brake system of the motor vehicle;
converts the hydraulic brake line pressure level to the corresponding electrical signal; and
provides the corresponding electrical signal to the electrical power output apparatus.

4. The vehicle brake light system of claim 1 wherein the brake light controller causes electrical power to be applied to:
a first portion of said braking effort intensity indicating lights during a first relative degree of braking effort being sensed by the brake light controller;
a second portion of said braking effort intensity indicating lights during a second relative degree of braking effort greater than the first relative degree of braking effort being sensed by the brake light controller; and
a third portion of said braking effort intensity indicating lights during a third relative degree of braking effort greater than the second relative degree of braking effort being sensed by the brake light controller.

5. The vehicle brake light system of claim 4 wherein:
the second portion of said braking effort intensity indicating lights includes the first portion of said braking effort intensity indicating lights; and
the third portion of said braking effort intensity indicating lights includes the second portion of said braking effort intensity indicating lights.

6. The vehicle brake light system of claim 5 wherein:
said braking effort intensity indication lights are aligned in a row;
the first portion of said braking effort intensity indicating lights is immediately adjacent to the second portion of said braking effort intensity indicating lights; and
the second portion of said braking effort intensity indicating lights is immediately adjacent to the third portion of said braking effort intensity indicating lights.

7. The vehicle brake light system of claim 6 wherein said electrical power is applied in a manner whereby:
the first portion of said braking effort intensity indication lights is illuminated prior to the second portion of said braking effort intensity indication lights;
the second portion of said braking effort intensity indication lights is illuminated prior to the third portion of said braking effort intensity indication lights; and
the third portion of said braking effort intensity indication lights is illuminated after illumination of the second portion of said braking effort intensity indication lights.

8. The vehicle brake light system of claim 6 wherein the alert light is immediately adjacent one of the first portion of said braking effort intensity indication lights and the second portion of said braking effort intensity indication lights.

9. The vehicle brake light system of claim 8 wherein:
illumination of said braking effort intensity indication lights causes light visible as a first color scheme to be emitted from the lighting assembly; and
illumination of the alert light causes light visible as a second color scheme to be emitted from the lighting assembly.

10. The vehicle brake light system of claim 7 wherein:
the brake light controller includes a braking effort sensing apparatus and an electrical power output apparatus;
the braking effort sensing apparatus is configured for sensing the relative degree of braking effort corresponding to applied braking force within a brake system of a motor vehicle and providing a corresponding electrical signal to the electrical power output apparatus;
the electrical power output apparatus is electrically connected between the braking effort sensing apparatus and the brake light assembly; and
the electrical power output apparatus outputs electrical power to the brake light assembly dependent upon the corresponding electrical signal for causing said electrical power to be selectively applied to the first portion of said braking effort intensity indicating lights during the first relative degree of braking effort being sensed by the brake light controller, to the second portion of said braking effort intensity indicating lights during the second relative degree of braking effort greater than the first relative degree of braking effort being sensed by the brake light controller, to the third portion of said braking effort intensity indicating lights during the third relative degree of braking effort greater than the second relative degree of braking effort being sensed by the brake light controller and to the alert light during at least one of the prescribed braking effort upper threshold being sensed by the brake light controller and the brake light controller receiving the signal corresponding to the motor vehicle being stopped.

11. The vehicle brake light system of claim 10 wherein the braking effort sensing apparatus:
senses a hydraulic brake line pressure level within the brake system of the motor vehicle;
converts the hydraulic brake line pressure level to the corresponding electrical signal; and
provides the corresponding electrical signal to the electrical power output apparatus.

12. A vehicle brake light system, comprising:
a brake light assembly including a plurality of lights each configured for being selectively illuminated through the application of electrical power;
a braking effort sensing apparatus configured for sensing a relative degree of braking effort corresponding to applied braking force within a brake system of a motor vehicle, converts the relative degree of braking effort to a corresponding electrical signal and provides the corresponding electrical signal to the brake light assembly; and
an electrical power output apparatus electrically connected between the braking effort sensing apparatus and said lights of the brake light assembly, wherein the electrical power output apparatus causes electrical power to be selectively applied to at least a portion of said lights dependent upon the corresponding electrical signal and wherein the electrical power output apparatus causes electrical power to be intermittently applied to at least a portion of said lights during at least one of a prescribed braking effort upper threshold being sensed by the braking effort sensing apparatus and the electrical power output apparatus receiving a signal corresponding to the motor vehicle being stopped.

13. The vehicle brake light system of claim 12 wherein the braking effort sensing apparatus:
senses a hydraulic brake line pressure level within the brake system of the motor vehicle;
converts the hydraulic brake line pressure level to the corresponding electrical signal; and
provides the corresponding electrical signal to the electrical power output apparatus.

14. The vehicle brake light system of claim 13 wherein the brake light controller causes electrical power to be applied to:
a first portion of said lights during a first relative degree of braking effort being sensed by the brake light controller;
a second portion of said lights during a second relative degree of braking effort greater than the first relative degree of braking effort being sensed by the brake light controller; and
a third portion of said lights during a third relative degree of braking effort greater than the second relative degree of braking effort being sensed by the brake light controller.

15. The vehicle brake light system of claim 14 wherein:
the second portion of said lights includes the first portion of said lights; and
the third portion of said lights includes the second portion of said lights.

16. The vehicle brake light system of claim 15 wherein:
said lights are aligned in a row;
the first portion of said lights is immediately adjacent to the second portion of said lights; and
the second portion of said lights is immediately adjacent to the third portion of said lights.

17. The vehicle brake light system of claim 16 wherein said electrical power is applied in a manner whereby:
the first portion of said lights is illuminated prior to the second portion of said lights;
the second portion of said lights is illuminated prior to the third portion of said lights; and
the third portion of said lights is illuminated after illumination of the second portion of said lights.

18. A motor vehicle, comprising:
a brake system controller configured for outputting a brake effort signal proportional to a relative degree of braking effort;
a plurality of braking effort intensity indication lights each configured for being selectively illuminated through the application of electrical power;
an alert light configured for being selectively illuminated through the application of electrical power; and
a brake light controller electrically connected to the brake system controller, said braking effort intensity indication lights and the alert light, wherein the brake light controller causes electrical power to be selectively applied to at least a portion of said braking effort intensity indicating lights dependent upon the braking effort signal and wherein the brake light controller causes electrical power to be intermittently applied to the alert light during at least one of the braking effort signal corresponding to a prescribed braking effort upper threshold being sensed by the brake system controller and the brake light controller receiving a signal corresponding to the motor vehicle being stopped.

19. The vehicle brake light system of claim 18 wherein:
the brake light controller includes a braking effort sensing apparatus and an electrical power output apparatus;
the braking effort sensing apparatus is configured for sensing the relative degree of braking effort corresponding to applied braking force within a brake system of a motor vehicle and providing a corresponding electrical signal to the electrical power output apparatus;
the electrical power output apparatus is electrically connected between the braking effort sensing apparatus and the brake light assembly; and
the electrical power output apparatus outputs electrical power to the brake light assembly dependent upon the corresponding electrical signal for causing said electrical power to be selectively applied to said at least a portion of said braking effort intensity indicating lights dependent upon the relative degree of braking effort being sensed by the braking effort sensing apparatus and for causing said electrical power to be intermittently applied to the alert light during at least one of the prescribed braking effort upper threshold being sensed by the brake light controller and the brake light controller receiving the signal corresponding to the motor vehicle being stopped.

20. The vehicle brake light system of claim 19 wherein:
the braking effort sensing apparatus senses a hydraulic brake line pressure level within the brake system of the motor vehicle, converts the hydraulic brake line pressure level to the corresponding electrical signal and provides the corresponding electrical signal to the electrical power output apparatus;
the brake light controller causes electrical power to be applied to a first portion of said braking effort intensity indicating lights during a first relative degree of braking effort being sensed by the brake light controller, to a second portion of said braking effort intensity indicating lights during a second relative degree of braking effort greater than the first relative degree of braking effort being sensed by the brake light controller and to a third portion of said braking effort intensity indicating lights during a third relative degree of braking effort greater than the second relative degree of braking effort being sensed by the brake light controller;
the second portion of said braking effort intensity indicating lights includes the first portion of said braking effort intensity indicating lights;
the third portion of said braking effort intensity indicating lights includes the second portion of said braking effort intensity indicating lights;
said braking effort intensity indication lights are aligned in a row;
the first portion of said braking effort intensity indicating lights is immediately adjacent to the second portion of said braking effort intensity indicating lights; and
the second portion of said braking effort intensity indicating lights is immediately adjacent to the third portion of said braking effort intensity indicating lights; and
said electrical power is applied in a manner whereby the first portion of said braking effort intensity indication lights is illuminated prior to the second portion of said braking effort intensity indication lights, the second portion of said braking effort intensity indication lights is illuminated prior to the third portion of said braking effort intensity indication lights and the third portion of said braking effort intensity indication lights is illuminated after illumination of the second portion of said braking effort intensity indication lights.
